(19) United States
(12) Patent Application Publication
(10) Pub. No.: US 2024/0190328 A1
(43) Pub. Date: Jun. 13, 2024

(54) Rollback Wrecker Vehicle

(71) Applicant: Billy Gay, Cottondale, FL (US)

(72) Inventor: Billy Gay, Cottondale, FL (US)

(21) Appl. No.: 18/536,979

(22) Filed: Dec. 12, 2023

Related U.S. Application Data
(60) Provisional application No. 63/431,866, filed on Dec. 12, 2022.

(51) Int. Cl. B60P 3/12; B60P 1/43

(52) U.S. Cl. CPC B60P 3/122; B60P 1/433

(57) ABSTRACT

A rollback wrecker vehicle is disclosed. The wrecker vehicle features a pivotable truck bed, which can slide back and tilt downwards to form a ramp-like structure, facilitated by a hydraulic motor and a threaded rod assembly. The wrecker vehicle is particularly advantageous in confined spaces, enabling safer and more efficient vehicle loading onto the wrecker deck without causing damage. Additionally, the truck bed, varying in length from 15 to 24 feet, incorporates C-channels along the threaded rod assembly for added support and alignment. A wheel lift device is included which slides along the truck bed and employs a hydraulic cylinder to lift vehicles. The device includes a wheel lift member with yokes and a hydraulic cylinder for lifting vehicle wheels.

### CROSS-REFERENCE TO RELATED APPLICATION

The present application claims priority to, and the benefit of, U.S. Provisional Application No. 63/431,866, which was filed on Dec. 12, 2022 and is incorporated herein by reference in its entirety.

### FIELD OF THE INVENTION

The present invention generally relates to the field of rollback wrecker devices. More specifically, the present invention relates to a novel rollback wrecker vehicle design for enhanced space efficiency and vehicle safety during towing. The wrecker includes a pivotable truck bed, which can slide back and tilt downwards to form a ramp-like structure, facilitated by a hydraulic motor and a threaded rod assembly. A wheel lift device slides along the truck bed and employs a hydraulic cylinder to lift vehicles. The advanced wrecker model provides a significant improvement over standard rollback wreckers, offering safe and damage-free vehicle towing. Accordingly, the present disclosure makes specific reference thereto. Nonetheless, it is to be appreciated that aspects of the present invention are also equally applicable to other like applications, devices, and methods of manufacture.

### BACKGROUND

By way of background, rollback wrecker vehicles are a type of tow truck equipped with a bed that can be tilted and then pulled back onto the truck. The wrecker can load and unload vehicles. Further, rollback wrecker vehicles are typically used to tow vehicles that are damaged or inoperable. However, rollback wrecker vehicles can be challenging to operate. There is a risk of damaging the towed vehicle if a vehicle is not properly secured to the wrecker. The damage can happen due to inadequate fastening or incorrect positioning of the vehicle on the wrecker.

If the towed vehicle is not secured properly, there's a risk of the towed vehicle coming loose and falling off the wrecker. This can lead to accidents, causing damage to other vehicles on the road. The danger is heightened if the wrecker is moving at high speed or in heavy traffic. Traditional towing methods often rely on chains and other types of fasteners to secure vehicles. The chains can damage the towed vehicle and can also be inefficient and less reliable, increasing the risk of the towed vehicle becoming unsecured during transport.

Wrecker drivers are exposed to passing traffic and can suffer injuries while securing or unloading vehicles. Also, operating on roadsides, especially in high-traffic areas or during adverse weather conditions, poses significant risks to wrecker drivers. Standard rolling wreckers can also take longer to load vehicles. The prolonged loading time not only increases the risk for the wrecker driver but also poses a hazard to passing traffic, potentially leading to more accidents.

Therefore, there exists a long felt need in the art for an improved rollback wrecker vehicle to safely load and unload vehicles without damage. Additionally, there is a long felt need in the art for a redesigned rollback wrecker vehicle that improves the safety of rollback wrecker vehicle drivers. Moreover, there is a long felt need in the art for a rollback wrecker vehicle that provides improved security and fastening of a towed vehicle. Further, there is a long felt need in the art for an improved rollback wrecker vehicle that does not use chains for securing a towed vehicle. Furthermore, there is a long felt need in the art for an innovative rollback wrecker vehicle that safely pulls the vehicle onto the deck of the wrecker without damaging the vehicle. Also, there is a long felt need in the art for an innovative and user-friendly rollback wrecker vehicle that can be used for towing all types of vehicles and includes a hydraulic mechanism for sliding the truck bed back and down. Finally, there is a long felt need in the art for a rollback wrecker vehicle that reduces potential injury often associated with loading a disabled vehicle and eliminates faulty wrecker loading.

The subject matter disclosed and claimed herein, in one embodiment thereof, comprises a safe efficient rollback wrecker vehicle. The rollback wrecker vehicle further comprises a pivotable truck bed that slides back and angles down with hydraulics and a threaded rod assembly to form a ramp-like structure for loading vehicles. The mechanism is advantageous in situations where space in front of the vehicle to be towed is limited. The hydraulic motor is in the form of a worm device and is coupled to one end of the threaded rod assembly. The threaded rod assembly runs along the length of the truck bed. A wheel lift device is adapted to move along the truck bed, enabling for the lifting of one or more wheels of a vehicle for towing. The wheel lift device includes a lift member and yokes for securing wheels of the towing vehicle.

In this manner, the safe efficient rollback wrecker of the present invention accomplishes all of the forgoing objectives and provides users with a redesigned rollback wrecker vehicle to safely load and unload vehicles without damage. The truck bed of the wrecker slides back and angles down with hydraulics to create a ramp. A lift device is used instead of chains to safely pull the vehicle onto the deck of the wrecker without any damage. The movement of the truck bed reduces potential injury often associated with loading a disabled vehicle and eliminates damage to other vehicles due to faulty wrecker loading.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rollback wrecker vehicle. The rollback wrecker vehicle further comprises a pivotable truck bed. The truck bed is designed to slide backwards and tilt downwards using a hydraulic motor and a threaded rod assembly to form a ramp-like structure for loading vehicles. The mechanism is advantageous in situations where space in front of the vehicle to be towed is limited. The truck bed's sliding and tilting capabilities facilitate safer and more efficient loading of vehicles onto the wrecker deck without causing damage to the towed vehicle.

In another aspect, a rollback wrecker vehicle equipped with a hydraulic motor and a threaded rod assembly is disclosed. The hydraulic motor is in the form of a worm device and is coupled to one end of the threaded rod assembly. The threaded rod assembly runs along the length of the truck bed. The threaded rod assembly features a plurality of C-channels along its length for additional support and alignment. A wheel lift device slides along the truck bed and lifts off a vehicle using an integrated hydraulic cylinder.

In yet another embodiment, the safe efficient rollback wrecker vehicle is an improved version of a standard rollback wrecker vehicle and features a pivotable truck bed designed to slide back and tilt for safe and damage-free loading of vehicles.

The truck bed of the safe efficient rollback wrecker vehicle is equipped with a hydraulic motor and a threaded rod assembly, enabling the truck bed to slide back and angle downwards to facilitate easy towing.

The rollback wrecker vehicle includes a wheel lift device that is adapted to move along the truck bed, enabling for the lifting of one or more wheels of a vehicle for towing.

The truck bed can vary in length from about 15 feet to about 24 feet, and the threaded rod assembly features C-channels on both sides, with each C-channel measuring 3 inches in length and ½ inch in thickness.

The hydraulic motor is adapted to function similarly to a worm device like a Ramsey winch and can be positioned at one end of the threaded rod assembly and provides the power for moving the truck bed.

The wheel lift device includes a central bearing that runs along the threaded rod assembly, facilitating smooth movement up and down the truck bed.

The wheel lift device features a wheel lift member with a pair of yokes for gripping a vehicle's wheels, and a hydraulic cylinder for lifting the vehicle's wheels off the ground.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of the safe efficient rollback wrecker vehicle of the present invention in accordance with the disclosed structure;

FIG. 2 illustrates a planar view of the truck bed of the safe efficient rollback wrecker vehicle in accordance with the disclosed structure;

FIG. 3 illustrates a perspective view of a wheel lift device of the present invention in accordance with the disclosed structure; and

FIG. 4 illustrates a perspective view showing a lifting of a vehicle on the truck bed using the wheel lift device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved rollback wrecker vehicle to safely load and unload vehicles without damage. Additionally, there is a long felt need in the art for a redesigned rollback wrecker vehicle that improves the safety of rollback wrecker drivers. Moreover, there is a long felt need in the art for a rollback wrecker vehicle that provides improved security and fastening of a towed vehicle. Further, there is a long felt need in the art for an improved rollback wrecker vehicle that does not use chains for securing a towed vehicle. Furthermore, there is a long felt need in the art for an innovative rollback wrecker vehicle that safely pulls the vehicle onto the deck of the wrecker without damaging the vehicle. Also, there is a long felt need in the art for an innovative and user-friendly rollback wrecker vehicle that can be used for towing all types of vehicles and includes a hydraulic mechanism for sliding the truck bed back and down. Finally, there is a long felt need in the art for a rollback wrecker vehicle that reduces potential injury often associated with loading a disabled vehicle and eliminates faulty wrecker loading.

The present invention, in one exemplary embodiment, is a rollback wrecker vehicle equipped with a hydraulic motor and a threaded rod assembly. The hydraulic motor is in the form of a worm device and is coupled to one end of the threaded rod assembly. The threaded rod assembly runs along the length of the truck bed. The threaded rod assembly features a plurality of C-channels along its length for additional support and alignment. A wheel lift device slides along the truck bed and lifts off a vehicle using an integrated hydraulic cylinder.

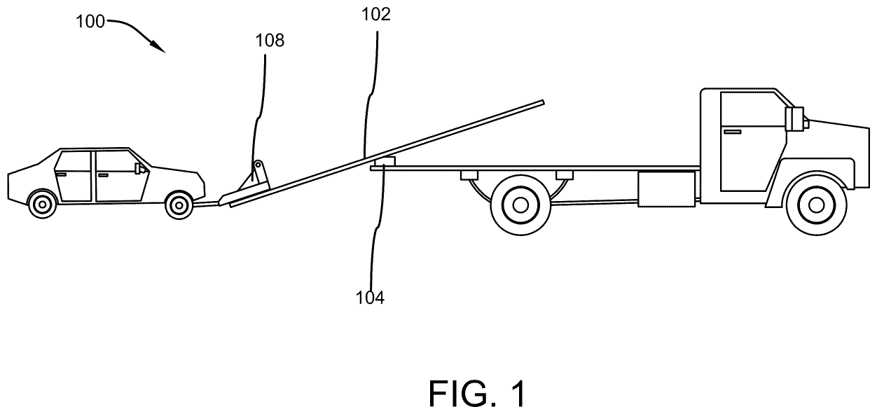

Referring initially to the drawings, FIG. 1 illustrates a side perspective view of the safe efficient rollback wrecker vehicle of the present invention in accordance with the disclosed structure. The safe efficient rollback wrecker vehicle 100 of the present invention is designed as an improved rollback wrecker vehicle 100 for safely loading a vehicle onto a wrecker deck without causing damage to the towed vehicle. The safe efficient rollback wrecker vehicle 100 resembles a standard rollback wrecker vehicle but has a pivotable truck bed 102. Unlike traditional wreckers, where the bed remains static, the truck bed 102 of the improved rollback wrecker vehicle 100 is designed to slide back and tilt. The truck bed 102 can slide back and is particularly useful where the space in front of the vehicle to be towed is limited to accommodate the truck bed 102. After sliding back, the bed 102 can angle downwards towards the ground to create a ramp-like effect.

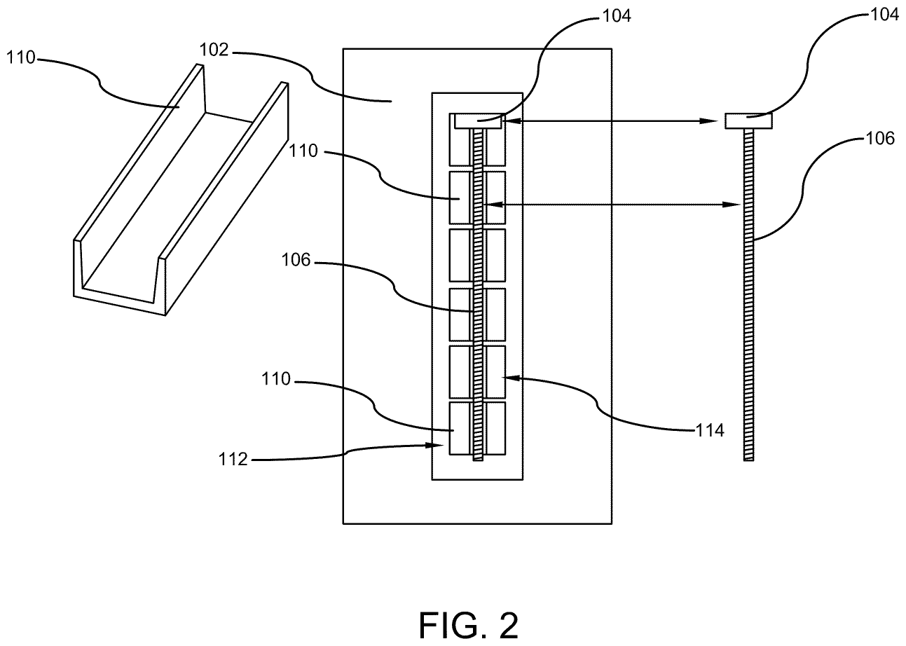

The truck bed 102 is coupled to a hydraulic motor 104 and a threaded rod assembly 106 for enabling the truck bed 102 to slide back and angle down for an easy towing of the truck bed 102. Referring to FIGS. 1 and 2, the threaded rod assembly 106 runs along the length of the truck bed 102. The rollback wrecker vehicle 100 includes a wheel lift device 108 which is configured to slide along the threaded rod assembly 106 for enabling lifting one or more wheels of a vehicle for towing.

The truck bed 102 can be in the range from about 15′ to about 24′ in different embodiments. Further, the threaded rod assembly 106 has a plurality of C-channels 110 on both sides 112, 114 thereof along the length of the threaded rod assembly 106. The threaded rod assembly 106 is preferably an ACME threaded rod assembly but can be of any conventional thread type assembly. Each C-channel 110 can be from 2″ to 4″ in length and from ⅜″ to ⅝″ in thickness.

The hydraulic motor 104 can be in the form of a worm device similar to a Ramsey winch and can be positioned at one end 107 of the truck frame (FIG. 1). The hydraulic motor 104 provides the power for movement of the truck bed 102, and the threaded rod assembly 106 translates this power into the precise movement of the bed 102.

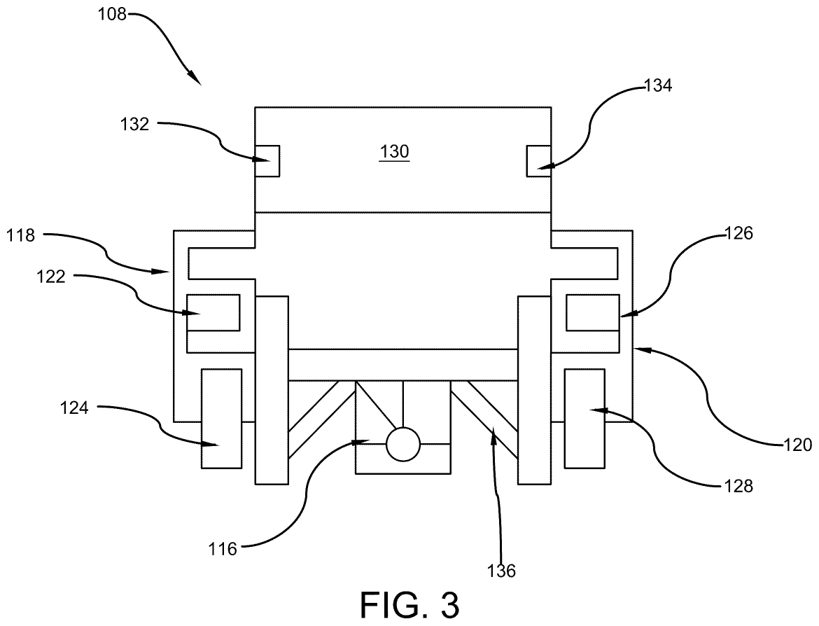

FIG. 3 illustrates a perspective view of a wheel lift device of the present invention in accordance with the disclosed structure. The wheel lift device 108 is designed to run along the threaded rod assembly 106 for towing a vehicle easily and without damage. More specifically, the wheel lift device 108 includes a central bearing 116 that is configured to run along the threaded rod assembly 106. The central bearing 116 is compatible with the threaded rod assembly 106 and helps the wheel lift device 108 move up and down along the truck bed 102.

The wheel lift device 108 includes a first bearing C-cover 118 and a second bearing C-cover 120. The first bearing C-cover 118 includes a first bearing 122 and a second bearing 124 to move along the plurality of C-channels 110 on the side 112 of the threaded rod assembly 106. Similarly, the second bearing C-cover 120 includes a corresponding first bearing 126 and a corresponding second bearing 128 to move along the plurality of C-channels 110 on the side 114 of the threaded rod assembly 106.

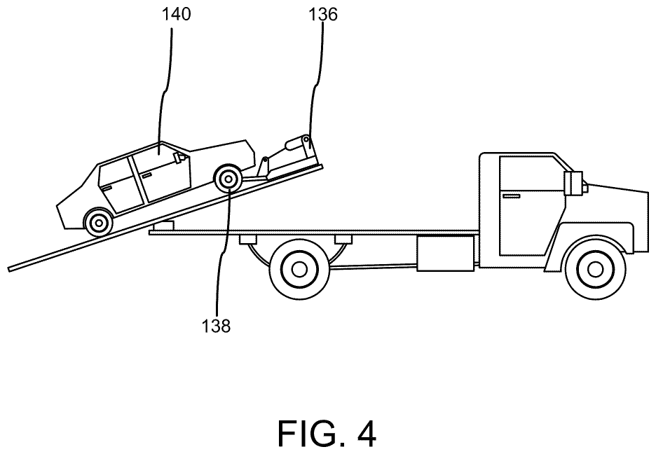

The wheel lift device 108 includes a wheel lift member 130 for pivotally connecting to a tow truck or vehicle frame as illustrated in FIG. 4. The wheel lift member 130 can be made from steel or any other durable metal. The wheel lift member 130 includes a pair of yokes 132, 134 for gripping opposing vehicle wheels connected to an axle. The yokes 132, 134 can be made of steel and are covered with rubber or other soft material to protect the tires.

A hydraulic cylinder 136 provides the power to wheel lift device 108 to lift a vehicle. The hydraulic cylinder 136 is connected to the wheel lift member 130 and the yokes 132, 134. Referring again to FIG. 4, the wheel lift member 130 is placed near the wheel 138 of a vehicle 140 and the hydraulic or pneumatic cylinder 136 is activated to lift the vehicle's wheels 138 off the ground.

It will be apparent to a person skilled in the art that the controlled and smooth operation of the truck bed 102 minimizes the risk of damaging the vehicle during loading and the system allows for quicker and more efficient loading, which is valuable in emergency or roadside situations without using chains and other fastening tools.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “safe efficient rollback wrecker vehicle”, “improved rollback wrecker vehicle”, “rollback wrecker”, “safe rollback wrecker”, and “damage free vehicle towing rollback wrecker” are interchangeable and refer to the safe efficient rollback wrecker vehicle 100 of the present invention.

Notwithstanding the forgoing, the safe efficient rollback wrecker vehicle 100 of the present invention can be of any suitable size and configuration as is known in the art without affecting the overall concept of the invention, provided that it accomplishes the above stated objectives. One of ordinary skill in the art will appreciate that the safe efficient rollback wrecker vehicle 100 as shown in the FIGS. is for illustrative purposes only, and that many other sizes and shapes of the safe efficient rollback wrecker vehicle 100 are well within the scope of the present disclosure. Although the dimensions of the safe efficient rollback wrecker vehicle 100 are important design parameters for user convenience, the safe efficient rollback wrecker vehicle 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rollback wrecker vehicle for loading a vehicle onto a wrecker deck, the rollback wrecker vehicle comprising:
a movable truck bed;
a hydraulic motor;
a threaded rod assembly; and
a wheel lift;
wherein said hydraulic motor and said threaded rod assembly coupled to said movable truck bed for sliding said movable truck bed rearward and tilting downward for access to a vehicle;
wherein said threaded rod assembly extending along a length of said movable truck bed;
wherein said wheel lift movable along a length of said threaded rod assembly;
wherein said wheel lift having a lift member including a first wheel yoke for attaching to a first wheel of the vehicle and a second wheel yoke for attaching to a second wheel of the vehicle;
wherein said movable truck bed slidable and tiltable from a first horizontal position to a second inclined position for attaching the vehicle;
wherein said movable truck bed slidable and tiltable from said second inclined position to said first horizontal position for loading the vehicle; and
further wherein said movable truck bed having a first terminal end in contact with the ground when in said second inclined position.

2. The rollback wrecker vehicle of claim 1, wherein said movable truck bed having a plurality of C-channels centrally mounted and extending along the length of said movable truck bed.

3. The rollback wrecker vehicle of claim 2, wherein said plurality of C-channels supporting said threaded rod assembly extending therethrough.

4. The rollback wrecker vehicle of claim 3, wherein each one of said plurality of C-channels having a length from 2 inches to 4 inches.

5. The rollback wrecker vehicle of claim 4, wherein said movable truck bed having a length from 15 feet to 24 feet.

6. The rollback wrecker vehicle of claim 5, wherein said wheel lift movable from a first position proximal to said first terminal end to a second position proximal to a second terminal end of said movable truck bed.

7. The rollback wrecker vehicle of claim 6, wherein said wheel lift having a central bearing configured to run along said threaded rod assembly.

8. The rollback wrecker vehicle of claim 7, wherein said wheel lift having a first bearing C-cover and a second bearing C-cover, wherein said first bearing C-cover having a first bearing and a second bearing to move along said plurality of C-channels on a first side of said threaded rod assembly, and further wherein said second bearing C-cover having a first bearing and a second bearing to move along said plurality of C-channels on a second opposing side of said threaded rod assembly.

9. The rollback wrecker vehicle of claim 8, wherein said wheel lift having a hydraulic cylinder for lifting said first wheel yoke and said second wheel yoke and lifting the first wheel and the second wheel off the ground.

10. A rollback wrecker vehicle for loading a vehicle onto a wrecker deck, the rollback wrecker vehicle comprising:
a movable truck bed;
a hydraulic motor;
a threaded rod assembly; and
a wheel lift;
wherein said hydraulic motor and said threaded rod assembly coupled to said movable truck bed for sliding said movable truck bed rearward and tilting downward for access to a vehicle;
wherein said threaded rod assembly extending along a length of said movable truck bed;
wherein said wheel lift movable along a length of said threaded rod assembly;
wherein said wheel lift having a lift member including a first wheel yoke for attaching to a first wheel of the vehicle and a second wheel yoke for attaching to a second wheel of the vehicle;
wherein said movable truck bed slidable and tiltable from a first horizontal position to a second inclined position for attaching the vehicle;
wherein said movable truck bed having a plurality of C-channels centrally mounted and extending along the length of said movable truck bed;
wherein said movable truck bed slidable and tiltable from said second inclined position to said first horizontal position for loading the vehicle;
wherein said movable truck bed having a first terminal end in contact with the ground when in said second inclined position;
wherein said wheel lift having a central bearing configured to run along said threaded rod assembly;
wherein said wheel lift having a first bearing C-cover and a second bearing C-cover;
wherein said first bearing C-cover having a first bearing and a second bearing to move along said plurality of C-channels on a first side of said threaded rod assembly; and
further wherein said second bearing C-cover having a first bearing and a second bearing to move along said plurality of C-channels on a second opposing side of said threaded rod assembly.

11. The rollback wrecker vehicle of claim 10, wherein said plurality of C-channels supporting said threaded rod assembly extending therethrough.

12. The rollback wrecker vehicle of claim 10, wherein each one of said plurality of C-channels having a length from 2 inches to 4 inches.

13. The rollback wrecker vehicle of claim 11, wherein said movable truck bed having a length from 15 feet to 24 feet.

14. The rollback wrecker vehicle of claim 12, wherein said wheel lift movable from a first position proximal to said first terminal end to a second position proximal to a second terminal end of said movable truck bed.

15. The rollback wrecker vehicle of claim 13, wherein said wheel lift having a hydraulic cylinder for lifting said first wheel yoke and said second wheel yoke and lifting the first wheel and the second wheel off the ground.

16. A rollback wrecker vehicle for loading a vehicle onto a wrecker deck, the rollback wrecker vehicle comprising:
a movable truck bed;
a hydraulic motor;
a threaded rod assembly; and
a wheel lift;
wherein said hydraulic motor and said threaded rod assembly coupled to said movable truck bed for sliding said movable truck bed rearward and tilting downward for access to a vehicle;
wherein said threaded rod assembly extending along a length of said movable truck bed;
wherein said movable truck bed having a plurality of C-channels centrally mounted and extending along the length of said movable truck bed;
wherein said wheel lift movable along a length of said threaded rod assembly;
wherein said wheel lift having a lift member including a first wheel yoke for attaching to a first wheel of the vehicle and a second wheel yoke for attaching to a second wheel of the vehicle;
wherein said movable truck bed slidable and tiltable from a first horizontal position to a second inclined position for attaching the vehicle;
wherein said movable truck bed slidable and tiltable from said second inclined position to said first horizontal position for loading the vehicle;
wherein said movable truck bed having a first terminal end in contact with the ground when in said second inclined position; and
further wherein said wheel lift movable from a first position proximal to said first terminal end to a second position proximal to a second terminal end of said movable truck bed.

17. The rollback wrecker vehicle of claim 16, wherein said plurality of C-channels supporting said threaded rod assembly extending therethrough.

18. The rollback wrecker vehicle of claim 16, wherein each one of said plurality of C-channels having a length from 2 inches to 4 inches.

19. The rollback wrecker vehicle of claim 17, wherein said wheel lift having a central bearing configured to run along said threaded rod assembly.

20. The rollback wrecker vehicle of claim 18, wherein said wheel lift having a first bearing C-cover and a second bearing C-cover, wherein said first bearing C-cover having a first bearing and a second bearing to move along said plurality of C-channels on a first side of said threaded rod assembly, and further wherein said second bearing C-cover having a first bearing and a second bearing to move along said plurality of C-channels on a second opposing side of said threaded rod assembly.
